(19) United States
(12) Patent Application Publication
(10) Pub. No.: US 2018/0149291 A1
(43) Pub. Date: May 31, 2018

(54) SLIDE BEARING PLATES, PIPE SUPPORT STANDS, AND RELATED METHODS OF USE

(71) Applicants: Sheryl SKAALERUD, Leslieville (CA); Dean Russell MAIER, Red Deer (CA)

(72) Inventors: Dean Russell MAIER, Red Deer (CA); Andrew John LONGMIRE, Leslieville (CA)

(21) Appl. No.: 15/611,757

(22) Filed: Jun. 1, 2017

(30) Foreign Application Priority Data
Nov. 30, 2016 (CA) 2950070
Mar. 2, 2017 (CA) 2959823

(51) Int. Cl. F16L 3/18; F16C 29/02

(52) U.S. Cl. CPC F16L 3/18; F16C 29/02; F16C 2240/06; F16C 2208/78; F16C 2220/60

(57) ABSTRACT

Slide bearing plates and related methods of use. A slide bearing plate has a body; a pipe shoe slide channel defined in a top face of the body; in which opposed walls and a base of the pipe shoe slide channel are made of a bearing material. A slide bearing plate has a body; a pipe shoe slide channel defined in a top face of the body; and a beam slide channel defined in a base face of the body. A slide bearing plate has: a body formed of a bearing material; and one or more of: a pipe shoe receptacle defined by a top face of the body; or a beam receptacle defined by a base face of the body. A pipe support stand has: a pipe; a pipe shoe supporting the pipe; a slide bearing plate supporting a base of the pipe shoe within the pipe shoe slide channel. A method involves installing a slide bearing plate between a pipe shoe and a support beam.

### TECHNICAL FIELD

This document relates to slide bearing plates, pipe support stands, and related methods of use.

### BACKGROUND

Pipeline stanchions may incorporate pairs of plates that form bearing surfaces to permit an overlying pipeline to slide relative to the stanchion.

### SUMMARY

A slide bearing plate is disclosed comprising: a body; a pipe shoe slide channel defined in a top face of the body; and in which opposed walls and a base of the pipe shoe slide channel are made of a bearing material.

A slide bearing plate is disclosed comprising: a body; a pipe shoe slide channel defined in a top face of the body; and a beam slide channel defined in a base face of the body.

A slide bearing plate is disclosed comprising: a body formed of a bearing material; and one or more of: a pipe shoe receptacle defined by a top face of the body; or a beam receptacle defined by a base face of the body.

A pipe support stand is disclosed comprising: a pipe; a pipe shoe supporting the pipe; and a slide bearing plate supporting a base of the pipe shoe within the pipe shoe slide channel.

A pipe support stand is disclosed comprising: a pipe; a pipe shoe supporting the pipe; a slide bearing plate supporting a base of the pipe shoe within the pipe shoe slide channel; and a beam supporting the slide bearing plate such that the slide bearing plate rests upon the beam with the opposed legs straddling opposed sides of the beam.

A method is disclosed comprising installing a slide bearing plate between a pipe shoe and a support beam.

In various embodiments, there may be included any one or more of the following features: The opposed walls have retainer arms that extend laterally inward partway over the pipe shoe slide channel. The pipe shoe slide channel is open-ended. A beam receptacle is defined in a base face of the body. Opposed legs, and a part that bridges the opposed legs, of the beam receptacle are made of the bearing material. The beam receptacle is open-ended. The beam receptacle is oriented perpendicular to the pipe shoe slide channel. The beam receptacle comprises a beam slide channel. The slide bearing plate comprises a fastener receiving aperture in the slide bearing plate for securing a fastener to a beam that supports a base of the body during use. The base of the pipe shoe slide channel is planar in shape. The slide bearing plate is formed of the bearing material. The slide bearing plate is formed by machining a block of the bearing material to shape. The bearing material has a coefficient of kinetic friction that is less than or equal to 0.2 in relation to a pipe shoe. The bearing material has a coefficient of kinetic friction that is less than 0.1, in relation to the pipe shoe. The bearing material comprises a non-metal. The bearing material comprises one or both nylon or ultra-high-molecular-weight polyethylene. The bearing material has a maximum operating temperature of 150° C. A beam supporting the slide bearing plate. Lateral stops secured to the beam on either side of the slide bearing plate. The pipe support stand comprises a fastener that secures the slide bearing plate to the beam. The pipe is insulated. Fitting the pipe shoe within an end of the pipe shoe slide channel. Sliding the slide bearing plate axially along the pipe shoe. Installing further comprising lifting the pipe shoe relative to the support beam to permit the pipe shoe to be fitted within an end of the pipe shoe channel. Securing the slide bearing plate to the beam.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of a pipe support stand incorporating a slide bearing plate and supporting an insulated pipe.

FIG. 2 is a section view of the pipe, pipe support stand, and slide bearing plate of FIG. 1 taken perpendicular to an axis of the pipe.

FIG. 3 is a section view of the pipe, pipe support stand, and slide bearing plate of FIG. 1 taken parallel to an axis of the pipe and offset from the axis of the pipe.

FIG. 4 is a perspective view of another embodiment of a pipe support stand incorporating a slide bearing plate and supporting an insulated pipe.

FIG. 5 is a section view of the pipe, pipe support stand, and slide bearing plate of FIG. 4 taken perpendicular to an axis of the pipe.

FIG. 6 is a section view of the pipe, pipe support stand, and slide bearing plate of FIG. 4 taken parallel to an axis of the pipe and offset from the axis of the pipe.

FIG. 7 is a schematic diagram of a length of a pipe supported by several pipe support stands.

FIG. 8 is an end elevation view of another embodiment of a slide bearing plate.

FIG. 9 is a side elevation view of the slide bearing plate of FIG. 8.

FIG. 10 is a section view of a pipe, pipe support stand, and another embodiment of a slide bearing plate, the section view being taken perpendicular to an axis of the pipe, with the pipe, pipe support stand and slide bearing plate mounted on a box beam.

FIG. 11 is a section view taken along the 11-11 section line in FIG. 10.

FIG. 12 is a section view of a pipe, pipe support stand, and the embodiment of the slide bearing plate from FIG. 10, taken perpendicular to an axis of the pipe, with the pipe, pipe support stand and slide bearing plate mounted on an I-beam.

FIG. 13 is a section view taken along the 13-13 section line in FIG. 12.

FIG. 14 is a top plan view of the slide bearing plate of FIG. 10.

FIG. 15 is an elevation view taken along the 15-15 view line in FIG. 14.

FIG. 16 is an elevation view taken along the 16-16 view line in FIG. 14.

### DETAILED DESCRIPTION

Immaterial modifications may be made to the embodiments described here without departing from what is covered by the claims.

Pipeline transport is the transportation of fluids, such as water, slurries, tailings, oil, and gas, across various distances through a pipeline. Pipelines are made up of a series of pipes connected end to end. Pipelines may be installed underground or above the ground. An above ground pipeline, such as an elevated pipeline, will often be supported by a plurality of stanchions (also known as pipe support stands) that are spaced from one another along a length of the pipeline, and that rise from the ground to seat the pipeline a predetermined distance above the ground. The seats of adjacent stanchions are often aligned relative to one another and secured in position.

During use, the pipes in a pipeline will experience a wide range of temperature fluctuation, which will cause portions of the pipeline to expand and contract. Some temperature fluctuations will occur abruptly, for example over a matter of minutes or hours, and others will occur over longer periods of time, for example over matter of days, weeks, or years. The pipeline itself will experience temperature fluctuation that is non-uniform across the length of the pipeline, leading to a situation where some portions of the pipeline will expand or contract to a greater degree than other portions. Temperature fluctuation in a pipeline is influenced by external and internal factors. External factors include ambient temperature, amount of direct sunlight, season, time-of-day, and weather. Above ground pipelines will often experience a wider range of temperature fluctuation from external factors than underground pipelines.

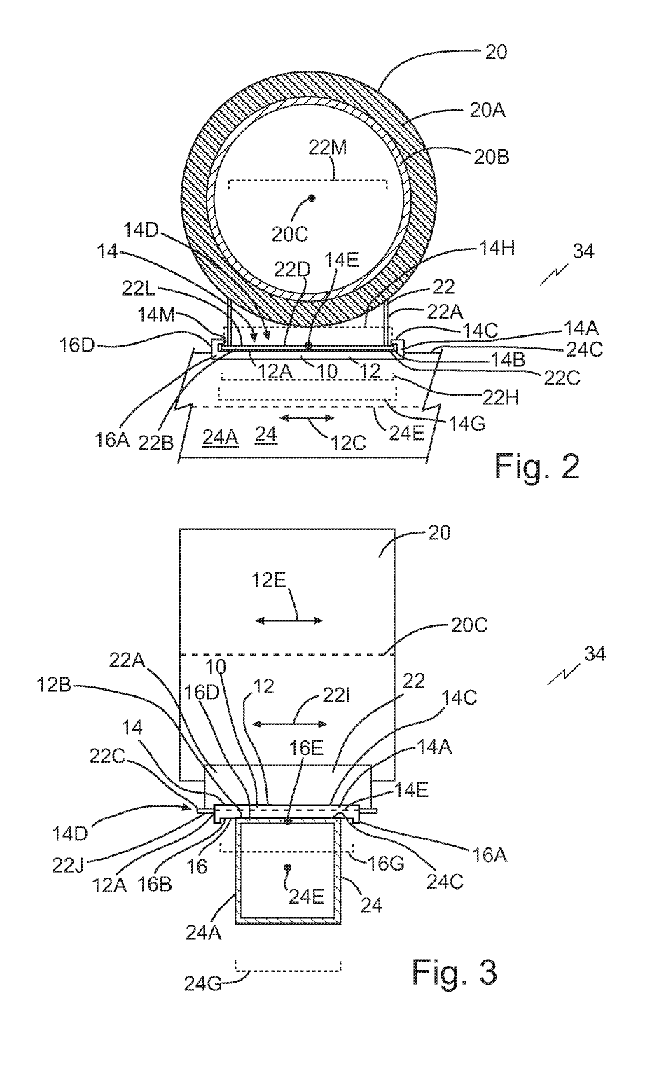

Internal factors that cause temperature fluctuation in a pipeline include the temperature and flux of fluids within the pipeline. The effects of thermal expansion and contraction on a pipeline will often be most pronounced along sections of pipe that periodically flow relatively hot or cold fluids. For example, a steam-assisted gravity drainage (SAGD) processing plant may output a heated slurry of bitumen and water, which will enter and cause a rapid and extensive thermal expansion of the pipeline. Referring to FIG. 2, a fluid conduit 20B that carries heated or cooled fluids will often be insulated from external factors by a jacket of insulation 20A, to prevent or reduce heat loss from the fluids to the ambient environment. As a result, an insulated pipeline may actually achieve a higher maximum temperature during fluid flow than in an analogous situation where no insulation is used.

Thermal expansion and contraction may cause a pipeline to extend or retract in axial length, leading to various potentially detrimental effects on the pipeline. An extended or retracted pipe or section of pipeline will create compression or tension, respectively, in the pipeline, which can lead to pipeline damage. Some portions of a pipe or pipeline may also experience a different thermal expansion or contraction than other portions. In general, axial expansion and contraction of the pipes in a pipeline may lead to bending or buckling of pipes relative to one another. In some cases, a pipe may jog or jump out of position from its seat upon a respective stanchion, leading to pipe failure, sagging, or other forms of pipe damage, often in remote areas where the pipeline may be difficult to access, monitor, or fix.

Pipeline stanchions may incorporate bearing surfaces or parts that permit the overlying pipeline to slide relative to the stanchion, in order to reduce the occurrence of bending, buckling, and jumping caused by an expanding or contracting pipe. For example, a pair of aluminum or polished stainless steel or ceramic plates may be welded to the bottom of a pipe shoe and the top of a pipe stanchion, to face one another during use and to permit 360 degrees of relative slide between the stanchion and pipeline. In another example one of the plates may be replaced with a polytetrafluoroethylene (PTFE) plate that is bonded or rigidly constrained by a retainer frame. Over time the PTFE plate may extrude out of the frame, or may delaminate from the under or overlying structure to which it is bonded.

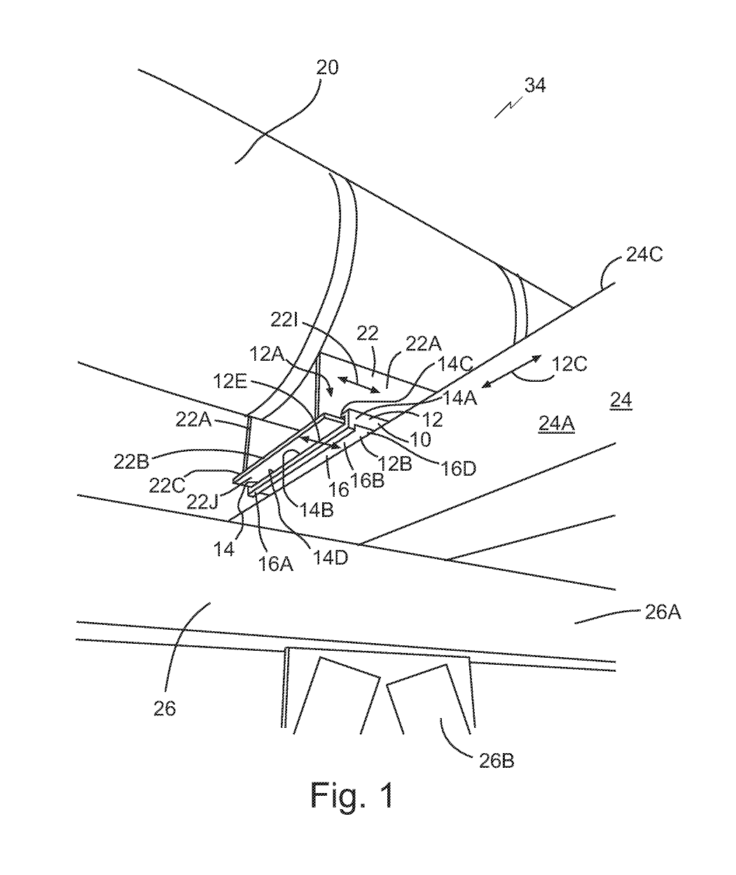

Referring to FIGS. 1-3, a slide bearing plate 10 is illustrated as part of a pipe support stand 34 that supports a pipe 20. Referring to FIG. 1, slide bearing plate 10 may comprise a body 12 with a top face 12A and a base face 12B. Referring to FIGS. 1-3, a receptacle, such as a slide channel 14, may be formed in top face 12A and shaped to receive a pipe shoe 22. Referring to FIGS. 1 and 3, a receptacle, such as a slide channel 16, may be formed in base face 12B and shaped to receive a beam 24 or other suitable upper part of a support stand 34. Referring to FIGS. 2 and 3, in use plate 10 may be positioned between pipe shoe 22 and beam 24, for example with body 12 positioned beneath pipe shoe 22 and above beam 24. Referring to FIG. 1, beam 24 may be positioned above a lower part 26 of the pipe support stand 34, for example a further support beam 26A, which for example runs in a transverse direction relative to beam 24, and from which may depend ground engaging members, for example legs 26B.

Referring to FIGS. 1-4, the pipe shoe slide channel 14 may be shaped to retain, and permit controlled sliding, of the pipe shoe 22 within the channel 14 during use. Pipe shoe slide channel 14 may be defined by opposed walls 14A and a base 14B, for example a planar base, formed in the top face 12A of the plate 10. During use, the pipe shoe 22 may fit within the channel 14, with a base part, for example a base plate 22B, of the pipe shoe 22, resting upon the base 14B of the channel 14. Base 14B of the channel 14 may form a bearing surface, for example if pipe-shoe-contacting surfaces of the base 14B are made of a bearing material, upon which base face 22J of base plate 22B contacts and slides across, for example along opposed axial directions 22I, which may be parallel to pipe axis 20C.

Referring to FIGS. 1-3, one or both axial ends 14D of the pipe shoe slide channel 14 may be open-ended as shown. Providing one or both open axial ends may facilitate installation of the plate 10 on the pipe shoe 22, by permitting axial entry of the pipe shoe 22 to pipe shoe slide channel 14 from either end of axial ends 14D. Referring to FIGS. 1 and 2, providing one or both open axial ends may increase the range of axial sliding motion possible along the channel 14, as the base plate 22B is permitted to slide into positions where an axial end 22D of the base plate 22B cantilevers in an axial direction past a respective axial end 14D of guide channel 14.

Referring to FIG. 2, the walls 14A of channel 14 may be structured to retain, and permit controlled sliding of, the pipe shoe 22 within the channel 14 during use. Walls 14A may form lateral stops that constrain lateral movement of pipe shoe 22 within and relative to channel 14. Lateral in this document is understood as referring to movement along an axis, which is horizontal and perpendicular to a second axis. When referring to walls 14A forming lateral stops the second axis is channel axis 14E. Nominal deviations from perpendicularity and horizontality are permitted. Uprights or walls 14A may have a suitable shape and orientation relative to one another, for example if pipe-shoe-facing surfaces of walls 14A are planar and parallel to one another as shown. Other wall shapes may be used, for example curved, angled, sloped (relative to horizontal and/or vertical planes) or other shapes, including combinations of same. Other orientations of walls relative to one another may be used, for example parallel walls, converging, diverging, others, or combinations of same.

Walls 14A may each form a bearing surface, for example if a pipe-shoe-contacting surface of the walls 14A is made of a bearing material. A bearing surface on walls 14A may facilitate the sliding of pipe shoe 22 within channel 14 along axis 14E. By contrast, a non-bearing material such as iron or steel may create friction and bind with flanged edges 22C of base plate 22B on contact.

Walls 14A may be spaced to reduce friction between pipe shoe 22 and channel 14. For example, the channel 14 may be structured such that a distance 14G, such as a minimum separation distance, between opposed walls 14A of the channel 14 is greater than a lateral width 22H, such as a maximum width, of base plate 22B of the pipe shoe 22. Providing channel 14 with distance 14G wider than width 22H provides restricted play for the base plate 22B to jog laterally back and forth within the channel 14 and decreases contact and friction created between walls 14A and flanged edges 22C of base plate 22B while pipe shoe 22 is within channel 14. In some cases the base of the pipe shoe 22 may lack flanged edges 22C but walls 14A may still be structured to laterally retain the base of the pipe shoe 22.

Referring to FIGS. 1-3, opposed walls 14A of the pipe slide channel 14 may have retainer arms 14C to retain the pipe shoe 22 within the channel 14 during use. Referring to FIG. 2, arms 14C may extend laterally inward, for example partway over pipe shoe slide channel 14. In some cases arms 14C extend towards one another. In some cases arms 14C extend one or both towards top face 12A of the body 12, or away from top face 12A of the body 12. Retainer arms 14C may project from respective opposed walls 14A at right angles, relative to the respective opposed walls 14A, or at other suitable angles. Other arm 14C shapes may be used, for example curved, angled, sloped (relative to horizontal and/or vertical planes) or other shapes, including combinations of same. Other orientations of arms 14C relative to one another may be used, for example parallel, converging, diverging, others, or combinations of same.

Referring to FIG. 2, arms 14C may be structured to restrict or prevent pipe shoe 22 from jumping or pulling out of channel 14, for example in a direction perpendicular to a plane defined by base 14B of pipe shoe slide channel 14. In the example shown, the arms 14C form vertical stops that limit the upward range of motion of the flanged ends or edges 22C of the base plate 22B, thus retaining the pipe shoe 22 in channel 14. Arms 14C may be structured such that a separation distance 14H between tips 14M of opposed retainer arms 14C of the pipe shoe slide channel 14 is a) greater than a width 22M, for example a maximum width, between exterior surfaces of a neck, defined in the example by opposed pipe retainer walls 22A, of the pipe shoe 22 (with arms 14C defining an opening for the neck), and b) less than a width 22H, for example a maximum width, of the base plate 22B.

Referring to FIG. 9, arms 14C may be one or both positioned or shaped to avoid contact with base plate 22B of pipe shoe 22 in use. For example, arms 14C may be positioned such that a distance 14N between base 14B and a bottom surface 14F of arm 14C is greater than a thickness or height 22N of base plate 22B, to define a gap between bottom surfaces 14F and a top face 22L of base plate 22B of pipe shoe 22. Such a gap may be defined when the pipe shoe 22 is in a neutral position resting by gravity upon base 14B of channel 14. Defining a gap in such a manner reduces friction between the plate 10 and the pipe shoe 22 during use. Arms 14C may each form a bearing surface, for example if one or both of surfaces 14F and tips 14M of the arms 14C are made of a bearing material. A bearing surface on arms 14C may facilitate the sliding of pipe shoe 22 within channel 14 along axis 14E.

Referring to FIGS. 1 and 3, beam slide channel 16 may be shaped to permit controlled sliding of the slide bearing plate 10 above and against the beam 24. Beam slide channel 16 may be defined by opposed legs 16A and a part that bridges the opposed legs 16A. Opposed legs 16A may straddle beam 24 to prevent body 12 from laterally slipping off of beam 24. The channel 16 may effectively saddle the beam 24. The part that bridges the legs 16A may be an under surface 16B, such as a planar surface as shown, formed in base face 12B of the plate 10. During use, beam 24 may fit within the channel 16, for example with surface 16B resting upon a top face 24C of the beam 24. Referring to FIGS. 1 and 2, surface 16B of the channel 16 may form a bearing surface, for example if surface 16B is made of a bearing material, which contacts and slides across top face 24C of beam 24, for example along opposed directions 12C.

Referring to FIGS. 1-3, one or both axial ends 16D of the beam slide channel 16 may be open-ended as shown. Referring to FIG. 2, providing one or both open axial ends may increase the range of axial sliding motion possible above and against the beam 24, as the plate 10 is permitted to slide into positions (not shown) where an axial end 16D cantilevers in an axial direction past a respective axial end of beam 24. Open axial ends also permit plate 10 to mount to a relatively long beam 24, for example a beam 24 that spans several laterally adjacent stanchions each supporting a respective pipe forming part of a pipe rack (not shown).

Referring to FIG. 3, the legs 16A may be structured to permit controlled sliding of plate 10 above and against beam 24, when beam 24 is positioned within channel 16, during use. Legs 16A may form lateral stops to constrain lateral movement of plate 10 along beam 24 relative to axis 16E. Legs 16A may have a suitable shape and orientation relative to one another, for example if beam-contacting surfaces of legs 16A are planar and parallel to one another as shown. Other shapes of legs 16A may be used, for example curved, angled, sloped (relative to horizontal and/or vertical planes) or other shapes, including combinations of same. Other orientations of legs 16A relative to one another may be used, for example parallel, converging, diverging, others, or combinations of same.

Referring to FIG. 3, legs 16A may each form a bearing surface, for example if beam-contacting surfaces of the legs 16A are made of a bearing material. A bearing surface on legs 16A may facilitate the sliding of plate 10 above and against beam 24, when beam 24 is positioned within channel 16, along an axis 16E of the channel 16 for example parallel to an axis 24E of the beam 24.

Referring to FIG. 3, legs 16A may be spaced to reduce friction between beam 24 and channel 16. For example, the channel 16 may be structured such that a distance 16G, such as a minimum separation distance, between opposed walls or legs 16A of the channel 16 is greater than a lateral width 24G, such as a maximum width, of beam 24. Providing channel 16 with distance 16G wider than width 24G provides play for the plate 10 to jog laterally back and forth above beam 24 and decreases contact and friction created between legs 16A and beam 24 while beam 24 is positioned within channel 16.

Referring to FIGS. 1-6 and 8-9, slide bearing plate 10 may comprise or be formed of a suitable bearing material. A bearing material reduces friction between moving parts that are in contact with one another, and permits non-destructive sliding of two parts relative to one another. Slide bearing plate 10 may be entirely formed of a bearing material, or may have only select parts, for example pipe shoe or beam facing contact surfaces, that are formed of a bearing material. In some cases part of the plate 10 may be formed of a non-bearing material. The bearing material may be a non-metal. In some examples the bearing material is one or both nylon and ultra-high-molecular-weight polyethylene (UHMWPE). A bearing material may be non-conductive, for example to isolate cathodic protection on the pipeline.

The bearing material may be adapted to have suitable properties, such as by being one or both chemical and high temperature resistant. One such example material is UHMWPE, which is odorless, nontoxic, corrosion resistant, and able to operate at relatively high temperatures. The bearing material may be resistant to corrosive chemicals, for example acids. The bearing material may have low to no moisture absorption, for example 3% or less, for further example 1.5 or less % absorption at 24 hours, with less than or equal to 10%, for example 0% moisture absorption at saturation, via American Society for Testing and Materials (ASTM) D570 test. The bearing material may be self-lubricating (for example via boundary lubrication). The bearing material may be resistant to abrasion, in some forms being five, ten, or fifteen times or more resistant to abrasion than carbon steel (UHMWPE may have a value of 100 for a sand wheel wear abrasion test. UHMWPE has better abrasion resistance than PTFE. Slide bearing plate 10 may comprise or be formed of a bearing material that has a maximum operating temperature of 60° C., 80° C., 100° C., 130° C., 150° C., or higher. Plate 10 may also have suitable load bearing characteristics, for example capable of bearing 10,000 psi or more of weight, such as 12,000 psi.

Referring to FIGS. 1-3, a bearing material may be selected to have a coefficient of friction suitable for facilitating sliding between shoe 22 and channel 14 and beam 24 and channel 16. In some cases the coefficient of kinetic friction of the bearing material is less than or equal to 0.2 (for example 0.12 or 0.07 for nylon and UHMWPE, respectively), for example less than or equal to 0.1, in relation to pipe shoe 22, beam 24, or both pipe shoe 22 and beam 24. Coefficients of kinetic friction may be determined according to a standardized test, for example ASTM D1894. Kinetic friction is the resistance to sliding of one surface over another once those surfaces are in relative motion. Below in Tables 1 and 2 are properties of several materials tested.

TABLE 1
Example characteristics of a UHMWPE bearing material

| PROPERTIES/UNITS | ASTM METHOD | VALUE |
|---|---|---|
| Specific Gravity | D792 | 1.15-1.16 |
| Tensile Strength PSI | D638 | 11000 |
| Elongation % | D638 | 20 |
| Tensile Modulus PSI | D638 | 350000 |
| Flexural Modulus PSI | D790 | 350000 |
| Izod Impact ft-lb/in2 | D256 | 0.7 |
| Coefficient of Friction | Dynamic D1894 | 0.07 |
| Melting Point C. | | 216 |
| Max Service Temp C. | | 177 Intermittent |
| Long Term Service Temp C. | | 127 |
| CTLE in/in/F. | D696 | 5 × 10(5) |
| Moisture Absorption % @ | D570 | 1.2 |
| 24 hours | | |
| Moisture Absorption % @ | D570 | 6 |
| saturation | | |

TABLE 2
Example characteristics of a nylon bearing material

| PROPERTIES/UNITS | ASTM METHOD | VALUE |
|---|---|---|
| Specific Gravity | D792 | 1.13 |
| Tensile Strength PSI | D638 | 12000 |
| Elongation % | D638 | 10 |
| Tensile Modulus PSI | D638 | 520000 |
| Flexural Modulus PSI | D790 | 435000 |
| Izod Impact ft-lb/in2 | D256 | 3.4 |
| Coefficient of Friction | Dynamic D1894 | 0.12 |
| Melting Point C. | | 216 |
| Max Service Temp C. | | 149 Intermittent |
| Long Term Service Temp C. | | 100 |
| CTLE in/in/F. | D696 | 5 × 10(5) |
| Moisture Absorption % @ | D570 | 2.5 |
| 24 hours | | |
| Moisture Absorption % @ | D570 | 6 |
| saturation | | |

Referring to FIGS. 1-6 and 8-9, slide bearing plate 10 may be formed via a suitable method, for example by machining a block of a suitable bearing material to shape. When made from a block the plate 10 forms a single-piece plain bearing. Machining is the process of cutting a piece of raw material into a desired shape and size by a controlled material-removal process. Machining the slide bearing plate 10 is a cost-effective method of forming the slide bearing plate 10, relative to conventional methods of forming bearing devices for pipe stanchions. In some cases opposed walls 14A and retainer arms 14C of the pipe shoe slide channel 14 and opposed legs 16A of the beam slide channel 16 may be formed via a single process, for example carried out a Computer Numerical Control (CNC) machine, or by a variety of manual machining processes. UHMWPE and nylon may be provided in solid polymer blocks, which include sheets, that are machined to shape.

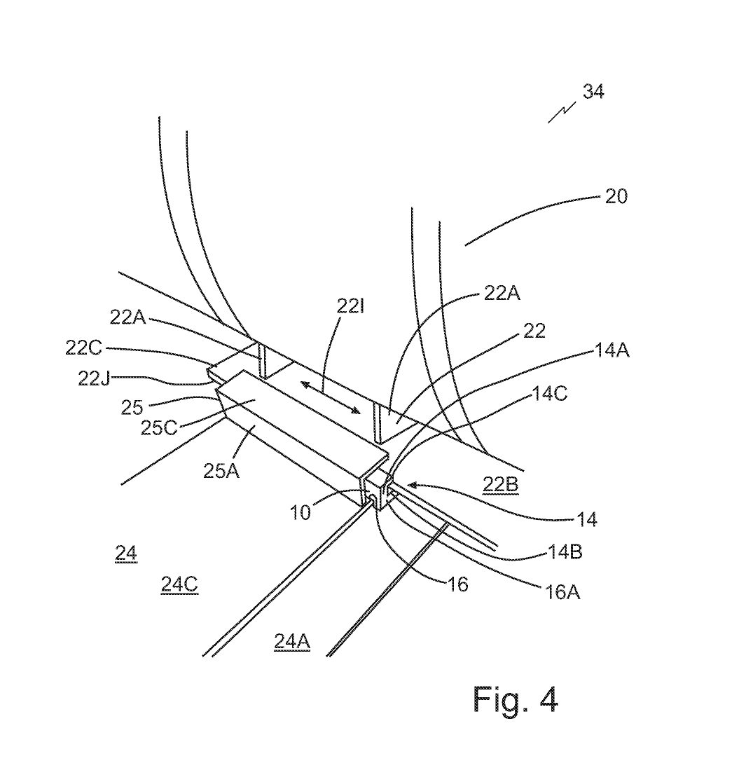

Referring to FIGS. 4-6, the slide bearing plate 10 may be secured to the beam 24. For example, lateral stops may be secured to the support stand 34 on either side of the plate 10 to retain plate 10 within between the lateral stops in use. For example, lateral stops may be formed by walls 25A that extend from, for example are welded to, top surface 24C of beam 24. Walls 25A may themselves be part of angle-iron or L-channel flanges or beams 25 that also include retainer arms 25C. Walls 25A may be integrally formed with or may be retrofitted by a suitable connection method to beam 24. Retrofitting may involve a stage of a method of installing the plate 10, with the stage carried out before, after, or during, placement of the plate 10 between the pipe shoe and the beam 24.

Walls 25A may be structured to retain plate 10 within the L-channel beams 25 during use to constrain lateral movement of the plate 10 within and relative to beams 25. Walls 25A may have a suitable shape and orientation relative to one another, for example if plate-facing surfaces of walls 25A are planar and parallel to one another as shown. Other wall shapes may be used, for example curved, angled, sloped (relative to horizontal and/or vertical planes) or other shapes, including combinations of same. Other orientations of walls relative to one another may be used, for example parallel walls, converging, diverging, others, or combinations of same. Although not shown, in some cases, such as where no channel 16 is provided, walls 25A may themselves form a channel in which the plate 10 is permitted to slide along an axis (not shown) perpendicular to the lateral stops.

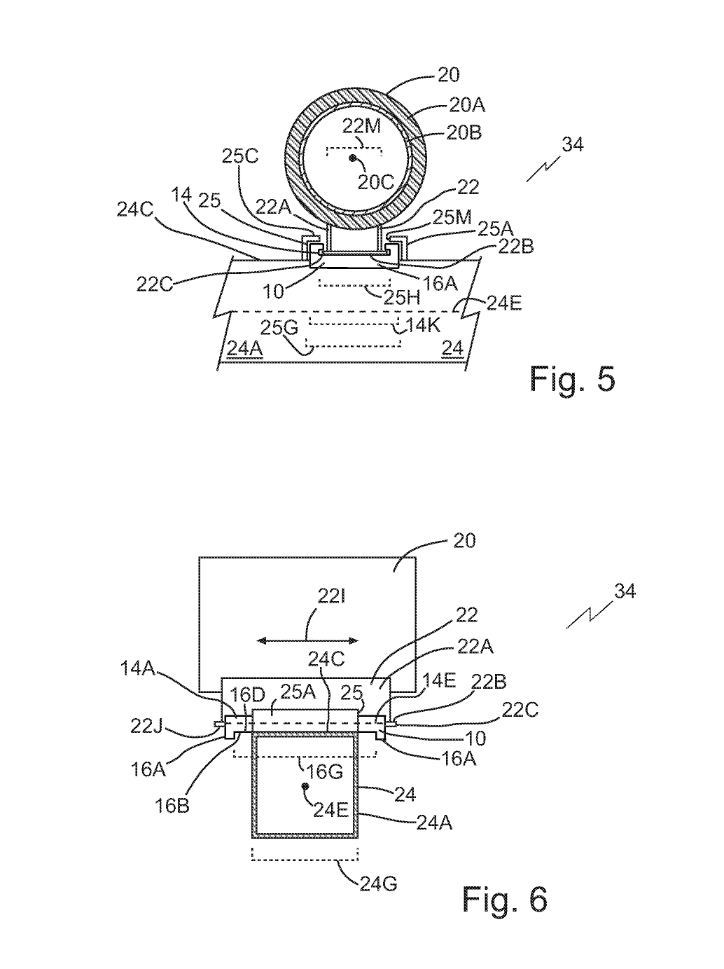

Referring to FIG. 5, walls 25A may be spaced to reduce friction between plate 10 and walls 25A. For example, walls 25A may be structured such that a distance 25G, such as a minimum separation distance, between walls 25A of the respective beams 25 is greater than a lateral width 14K, such as a maximum width, of the plate 10. Providing beams 25 with distance 25G wider than width 14K provides play for the plate 10 to jog laterally back and forth within one or both beams 25 and decreases contact and friction created between walls 25A and plate 10 during use.

Referring to FIGS. 4-5, each wall 25A may have respective retainer arms 25C. Retainer arms 25C may extend laterally inward, for example partway over plate 10. In some cases arms 25C extend towards one another. In some cases arms 25C extend one or both towards top face 12A of the plate 10, or away from top face 12A of the plate 10. Retainer arms 25C may project from respective opposed walls 25A at right angles, relative to the respective opposed walls 25A, or at other suitable angles. Other arm 25C shapes may be used, for example curved, angled, sloped (relative to horizontal and/or vertical planes) or other shapes, including combinations of same. Other orientations of arms 25C relative to one another may be used, for example parallel, converging, diverging, others, or combinations of same.

Referring to FIGS. 4-5, arms 25C may be structured to restrict or prevent plate 10 from jumping or pulling out from between the walls 25A, for example in a direction perpendicular to a plane defined by top surface 24C of beam 24. In the examples shown, the arms 25C form vertical stops that limit the upward range of motion of the opposed walls 14A of the pipe shoe slide channel 14 of the plate 10, thus retaining plate 10 between and within L-channel beams 25. Referring to FIG. 5, arms 25C may be structured such that a separation distance 25H between tips 25M of arms 25C is a) greater than a width 22M, for example a maximum width, between exterior surfaces of the neck, defined in the example by opposed pipe retainer walls 22A of the pipe shoe 22 (with arms 25C defining an opening for the neck), and b) less than a width 14K, for example a maximum width, of the plate 10.

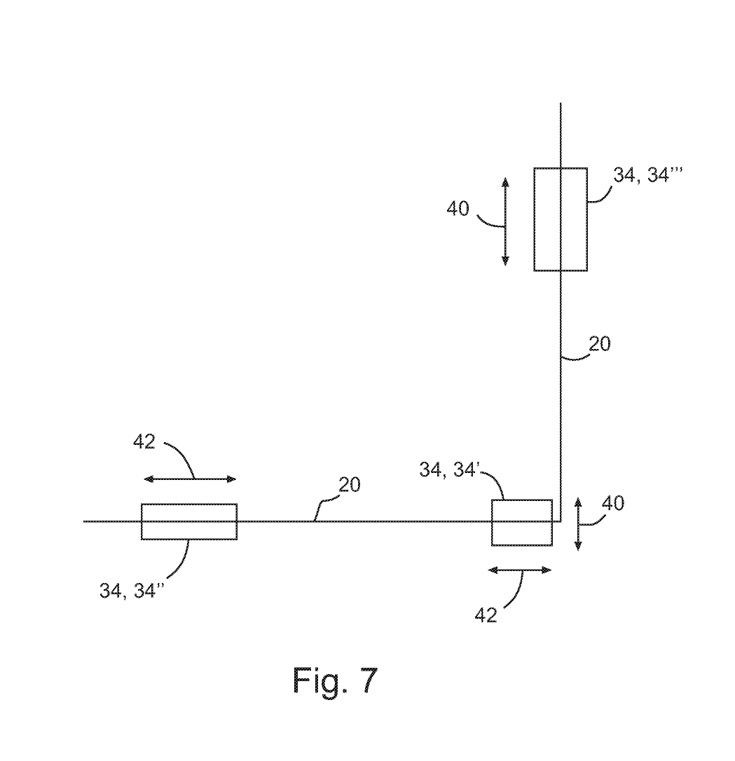

Referring to FIG. 7, a selected one or more of the pipe support stands 34 that support a pipeline may incorporate lateral stops to constrain plate 10. For example, a pipe support stand 34′ adjacent a corner or bend in the pipeline may lack lateral stops in order to permit the pipe 20 to move relative to the stand 34′ in a plane of movement defined by directions 40 and 42, which are perpendicular to one another. Such freedom of movement may be desired near a corner or bend in the pipeline to accommodate thermal expansion and contraction effects on either adjacent section of pipe 20. In other cases, such as with a pipe support stand 34″ that supports a straight or unbent section of pipe 20, lateral stops may be incorporated to restrict lateral motion and permit sliding only in an axial direction 42. Similarly, stand 34′″ may lack stops and thus may permit sliding only in axial direction 40. In other cases, lateral stops may be used on straight sections of pipe, and/or may be lacking on corner/bent sections of pipe.

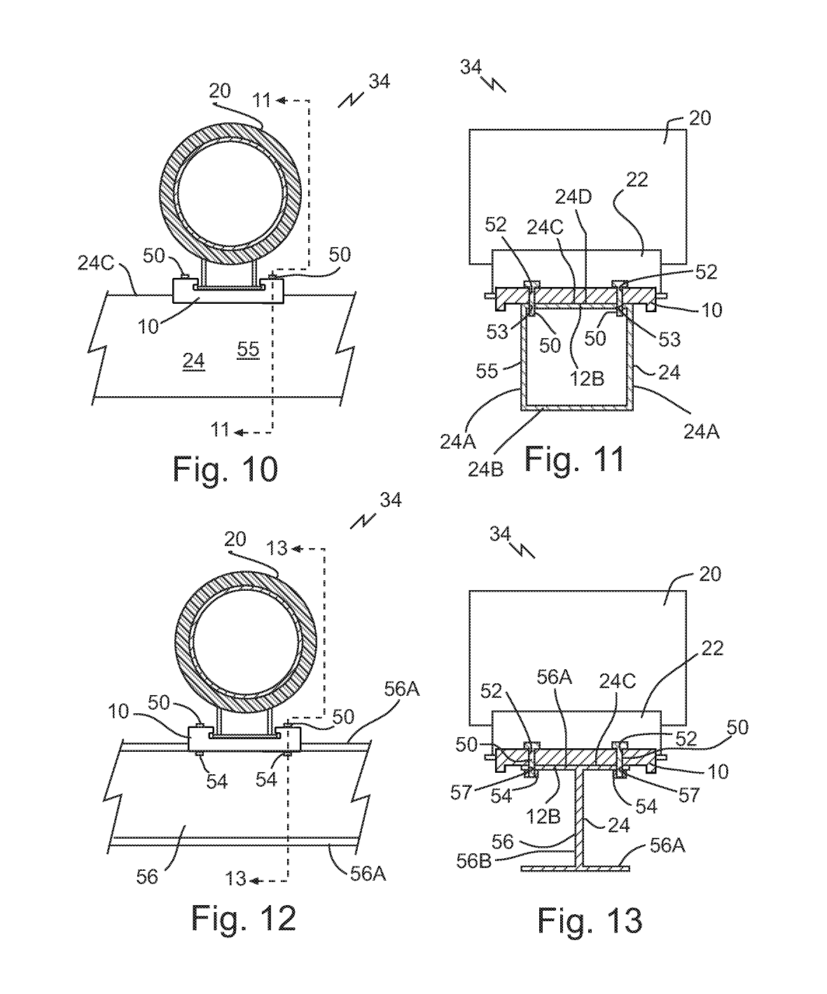

Referring to FIGS. 10-13, the slide bearing plate 10 may be secured to the beam 24 by one or more fasteners 50, such as bolts as shown. Referring to FIGS. 11 and 13, fasteners 50 may pass through one or more fastener receiving apertures 52, for example slots, holes and others, in the plate 10. As above, the beam 24 may support a base face 12B of the plate 10 in use. Fasteners 50 may prevent, restrict, or limit relative movement between plate 10 and beam 24. Referring to FIGS. 11 and 13, the beam 24 may take a variety of suitable cross-sectional shapes, such as a hollow square tubular beam 55 (FIG. 11) or an I-beam 56 (FIG. 13). A tubular beam 55 may have a square or rectangular cross-sectional shape defined by top and bottom walls 24D, 24B, respectively, and side walls 24A, whereas an I-beam may have a cross-sectional shape defined by top and bottom flange parts 56A separated by a stem 56B. Referring to FIG. 11, in some cases fastener-receiving threaded apertures 53 may be formed, for example tapped, in the top surface 24C of beam 55 to secure respective fasteners 50. Referring to FIG. 13, in some cases smooth-bore apertures 57 may be drilled through top surface 24C, for example of flange part 56A, of beam 56, with nuts 54 used to secure the fasteners 50 to the beam 56.

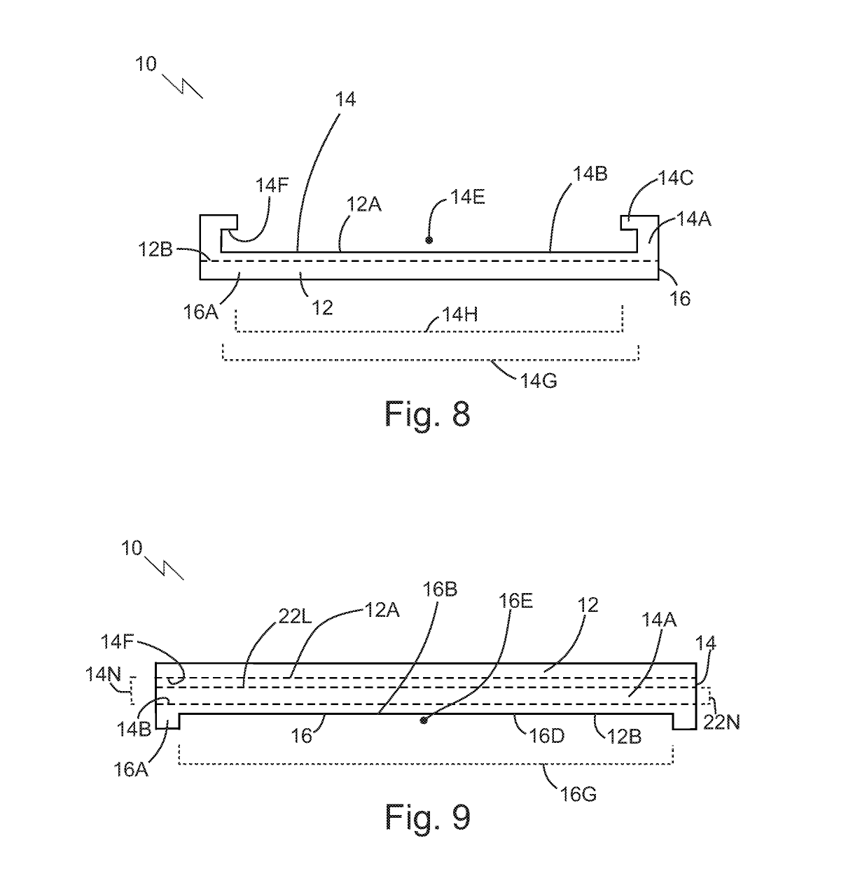

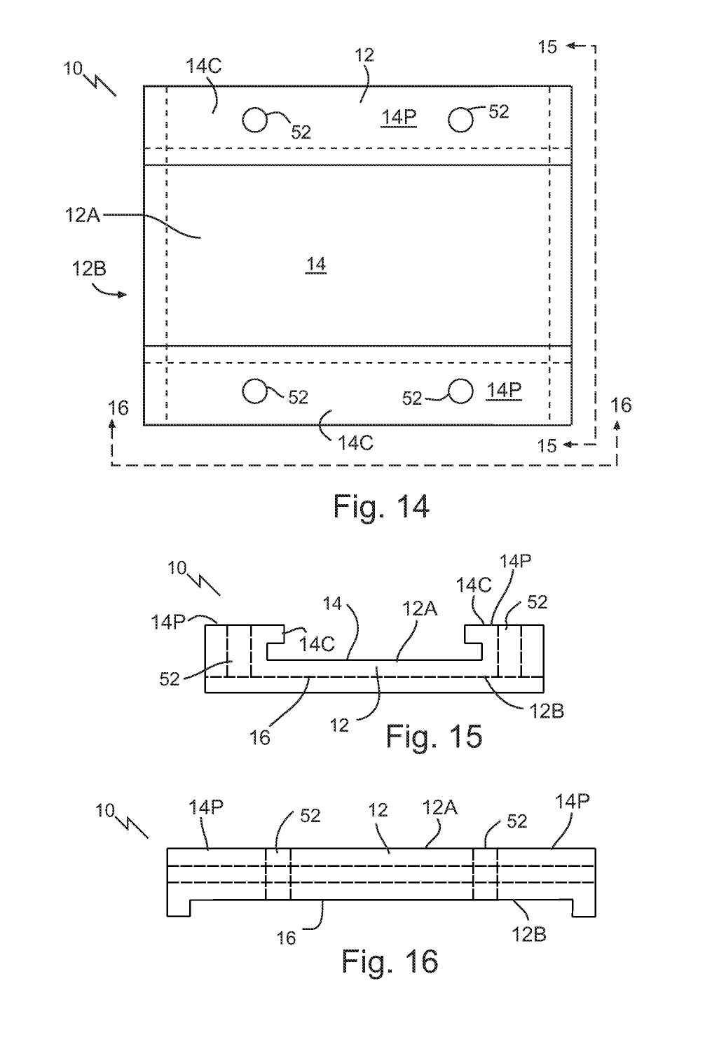

Referring to FIGS. 14-16, fastener receiving apertures 52 in plate 10 may extend between a top face 12A of plate 10, for example a top surface 14P of retainer arms 14C, and a base face 12B of plate 10. The plate 10 illustrated in FIGS. 14-16 is modified relative to the plate 10 illustrated in FIGS. 8-9 to increase the lateral width of the arms 14C, which define the thickest part of the plate, in order to position the mounting holes or apertures 52 for receiving a suitable size of fastener 50, such as four and a half inch bolts to do mount the plate 10 solidly onto the stand frame or beam 24. The design in FIGS. 14-16 may reduce the cost during installation and provide more material to increase the side loading of the plate 10 relative to that possible with the plate 10 of FIGS. 8-9. Apertures 52 may pass vertically through the plate 10 in use, for example perpendicular to a plane defined by the face 12A of the plate 10, although other orientations may be used. Referring to FIG. 13, a user may install plate 10 by forming, for example tapping or drilling, apertures 53 or 57 in beam 24, aligning such apertures 53 or 57 with apertures 50 in plate 10, and securing fasteners 50 through the aligned apertures. Other types of fasteners may be used, for example screws, pins, rivets, and others. Some fasteners 50 and corresponding apertures 52 may be selected to permit a degree of slide play between the plate 10 and the fasteners 50, for example if the apertures 52 form elongated slots or are over-sized in cross-sectional area relative to the cross-sectional area of the fasteners 50. Apertures used in this document include smooth bore, threaded, tapered, and other apertures. Fasteners 50 and apertures 52 may be used in addition to lateral stops 25 (FIG. 5), or instead of lateral stops 25 to avoid the material and labor costs associated with installing lateral stops 25. Use of fasteners 50 may decrease installation time of plate 10 and pipe support stand 34 relative to use of lateral stops 25. It may be advantageous to manufacture plate 10 with pre-formed or pre-drilled apertures 52 to provide the installer with a convenient option to secure the plate 10 to the underlying beam if desired. In other cases apertures 52 may be formed by a user on site prior to securing the plate 10 to the beam 24.

Referring to FIG. 1, pipe support stand 34 may be installed between pipe shoe 22 and beam 24 via a suitable method. In some cases, for example where the plate 10 is retrofitted to an existing support stand 34, the pipe shoe 22 may be lifted, for example using a crane or a jack such as a bottle jack (not shown), relative to the beam 24. The pipe shoe 22 may be fitted within an open axial end 14D of the slide channel 14, and the plate 10 slid axially along the pipe shoe 22 into position. The pipe shoe 22 may then be dropped or lowered into position over beam 24. Lateral stops, such as walls 25A may be welded to beam 24 to constrain the lateral movement of plate 10. The plate 10 may also be installed in new support stands 34 before or after construction of same, for example before, during, or after the pipe shoe is connected to the pipe, or before, during, or after the pipe shoe is mounted on the beam 24. Plate 10 may be formed of more than one plates, or may be a single integral unit.

In some cases, one or both of the receptacle in the top face 12A or the receptacle in the base face 12B lack open axial ends. In some cases such receptacles do not permit sliding in axial or lateral directions. In some cases, one or both of such receptacles may have a closed axial end or closed axial ends to permit limited axial sliding. In some cases one of the receptacles is lacking from the plate 10. In some cases, the pipe shoe receptacle or beam receptacle or both the pipe shoe receptacle and beam receptacle of body 12 do not form a channel. In some cases an indent or slot is present but the adjacent part (beam or pipe shoe) does not fit within the indent or slot.

Slide bearing plate 10 may form part of a pipe support that hangs from a structure above the pipeline. Slide bearing plate 10 may be formed of a greaseless bearing material. Plate 10 may be used with or without a lubricating fluid to improve bearing properties. Opposed walls of one or both the pipe shoe slide channel or beam channel may be formed of a metal, for example polished stainless steel. One or both of base 14B of the channel 14, or surface 16B of channel 16, may have a non-planar shape. One or both of base 14B, surface 16B, walls 14A, and legs 16A may be ridged or textured, for example to reduce friction by reducing contact surface area. Retainer arms 14C of pipe shoe slide channel 14 may form overhangs or anchors. Opposed legs 16A of beam slide channel 16 may form rails. In some cases, pipe 20 is an underground pipe or is situated along the ground. Pipe 20 may form part of a pipeline used in a refinery operation. Beam 24 may be an I-beam, box-beam, C-channel beam, or have another suitable shape, or may be a structure that protrudes from a base structure but that has an exterior shape similar to a beam.

In some cases a worn-out plate 10 may be replaced with a new plate 10. Pipe shoe 22 may form a foot or frame that seats the pipe, and slide bearing plate 10 may form a corresponding shoe to fit or seat upon a lower part of the support stand 34. A plate or pad comprising a bearing material may be positioned between pipe shoe 22 and slide bearing plate 10. Body 12 may rest on beam 24 in a loosely disposed position, without fasteners, connectors, or bonds between body 12 and beam 24. Pipe shoe 22 may rest on body 12 in a loosely disposed position, without fasteners, connectors, or bonds between shoe 22 and body 12.

In some cases, parts of slide bearing plate 10, for example opposed walls 14A and base 14B of the pipe shoe slide channel 14, are formed of a bearing material while other parts of slide bearing plate 10, for example retainer arms 14C of pipe shoe slide channel 14, are formed of a non-bearing material. In some cases, slide bearing plate 10 is formed of different bearing materials having different coefficients of kinetic friction. For example, top face 12A of body 12 may comprise an upper bearing surface formed of nylon and base face 12B of body 12 may comprise a lower bearing surface formed of UHMWPE. For example, top face 12A of body 12 may comprise an upper bearing surface having a coefficient of friction of 0.11 and base face 12B of body 12 may comprise a lower bearing surface having a coefficient of friction of 0.15.

The pipeline may be used to convey fluids used or produced via a steam assisted gravity drainage (SAGD) operation. The plate 10 may be used in association with a pipeline that is used to convey fluids used or produced in other processes such as cogeneration, sawmills, refineries, oil batteries, gas plants with compression, and other applications where the stand 34 supports a pipe with heated fluids or gases. The pipe support stand 34 may comprise the beam 24, or may otherwise provide a frame upon which the plate 10 is able to rest, for example slide along. Words such as horizontal, vertical, up, down, above, below, upper, lower, base, top, side, and others are relative and not constrained to meanings tied to direction of gravity on the earth unless context dictates otherwise. Bearing surfaces may be provided by bonding or lining body 12 with a bearing material, by forming body 12 out of a bearing material, or by another suitable method.

In the claims, the word “comprising” is used in its inclusive sense and does not exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A slide bearing plate comprising:
a body;
a pipe shoe slide channel defined in a top face of the body; and
in which opposed walls and a base of the pipe shoe slide channel are made of a bearing material.

2. The slide bearing plate of claim 1 in which the opposed walls have retainer arms that extend laterally inward partway over the pipe shoe slide channel.

3. The slide bearing plate of claim 1 in which the pipe shoe slide channel is open-ended.

4. The slide bearing plate of claim 1 further comprising a beam receptacle defined in a base face of the body.

5. The slide bearing plate of claim 4 in which opposed legs, and a part that bridges the opposed legs, of the beam receptacle are made of the bearing material.

6. The slide bearing plate of claim 5 in which the beam receptacle is open-ended.

7. The slide bearing plate of claim 4 in which the beam receptacle is oriented perpendicular to the pipe shoe slide channel.

8. The slide bearing plate of claim 4 in which the beam receptacle comprises a beam slide channel.

9. The slide bearing plate of claim 1 further comprising a fastener receiving aperture in the slide bearing plate for securing a fastener to a beam that supports a base of the body during use.

10. The slide bearing plate of claim 1 in which the base of the pipe shoe slide channel is planar in shape.

11. The slide bearing plate of claim 1 formed of the bearing material.

12. The slide bearing plate of claim 11 formed by machining a block of the bearing material to shape.

13. The slide bearing plate of claim 1 in which the bearing material has a coefficient of kinetic friction that is less than or equal to 0.2 in relation to a pipe shoe.

14. The slide bearing plate of claim 13 in which the bearing material has a coefficient of kinetic friction that is less than 0.1, in relation to the pipe shoe.

15. The slide bearing plate of claim 11 in which the bearing material comprises a non-metal.

16. The slide bearing plate of claim 1 in which the bearing material comprises one or both nylon or ultra-high-molecular-weight polyethylene.

17. The slide bearing plate of claim 1 in which the bearing material has a maximum operating temperature of 150° C.

18. (canceled)

19. A slide bearing plate comprising:
a body formed of a bearing material; and
one or more of:
a pipe shoe receptacle defined by a top face of the body; or
a beam receptacle defined by a base face of the body.

20. A pipe support stand comprising:
a pipe;
a pipe shoe supporting the pipe; and
the slide bearing plate of claim 1 supporting a base of the pipe shoe within the pipe shoe slide channel.

21-25. (canceled)

26. A method comprising installing the slide bearing plate of claim 1 between a pipe shoe and a support beam.

27-29. (canceled)
